(19) United States
(12) Patent Application Publication
(10) Pub. No.: US 2024/0034600 A1
(43) Pub. Date: Feb. 1, 2024

(54) MOBILE CRANE WITH ADJUSTABLE COUNTERWEIGHT DEVICE, COUNTERWEIGHT DEVICE AND METHOD FOR MOUNTING SUCH A DEVICE

(71) Applicant: Liebherr-Werk Ehingen GmbH, Ehingen/Donau (DE)

(72) Inventor: Lars EBERHARDT, Staig (DE)

(21) Appl. No.: 18/357,742

(22) Filed: Jul. 24, 2023

(30) Foreign Application Priority Data
Jul. 26, 2022 (DE) 10 2022 118 694.6

(51) Int. Cl. B66C 23/76; B66C 23/80

(52) U.S. Cl. CPC B66C 23/76; B66C 23/80

(57) ABSTRACT

The disclosure relates to a mobile crane comprising a mobile undercarriage, an upper carriage rotatably mounted on the undercarriage, and a counterweight device which can be coupled to the upper carriage and which comprises a counterweight base plate and at least one connection element extending substantially perpendicularly to the counterweight base plate and connected thereto for lifting and coupling the counterweight device to the upper carriage. The counterweight device may comprise a carrier plate connectable to the connection element above the counterweight base plate, wherein at least one pivot beam is mounted on the carrier plate so as to be pivotable about a vertical axis, on which first counterweight elements are stackable. The disclosure further relates to a counterweight device for a mobile crane according to the disclosure and to a method for mounting the counterweight device on the upper carriage of a mobile crane according to the disclosure.

### CROSS REFERENCE TO RELATED APPLICATION

The present application claims priority to German Patent Application No. 10 2022 118 694.6 filed on Jul. 26, 2022. The entire contents of the above-listed application are hereby incorporated by reference for all purposes.

### TECHNICAL FIELD

The present disclosure relates to a mobile crane, to a counterweight device for such a mobile crane, as well as to a method for mounting a counterweight device on such a mobile crane.

### BACKGROUND

Mobile cranes typically comprise a wheeled or crawler undercarriage, an upper carriage mounted on the undercarriage so as to rotate about a vertical axis, a boom pivotally mounted on the upper carriage, and a counterweight device also known as an upper carriage ballast. The counterweight applies a counter moment to the load moment in any position of the upper carriage via a lever arm and therefore co-rotates with the upper carriage.

### SUMMARY

While smaller mobile cranes often carry all equipment for use on the construction site as so-called taxi cranes, even in public road traffic, larger mobile cranes are not able to do this, however, so that it is necessary to dismantle crane components and, in particular, the counterweight device completely or partially for transport in public road traffic and to mount it on site. In the case of crawler cranes, too, the counterweight device typically has to be dismantled for transport and mounted on the upper carriage at the place of operation.

It is therefore known from the prior art to provide a carrier plate or a counterweight base plate with connection elements for detachable connection to the upper carriage, on which several counterweight elements can be stacked. The upper carriage is provided with a ballast device capable of picking up the counterweight device comprising the counterweight base plate and the counterweight elements stacked thereon at the connection elements from the floor or from a support area on the undercarriage for assembly and lifting them to the upper carriage. For disassembly, the counterweight base plate with the counterweight elements can be placed back on the floor or the undercarriage.

For this purpose, the ballast device usually comprises one or more hydraulic ballast cylinders which extend downward, are engaged with the connection elements of the counterweight device and, by retraction, lift the counterweight device to the upper carriage.

In the prior art, one of the connection elements used are cylindrical receiving tubes which are welded to the counterweight base plate and project vertically upwards from it. The counterweight elements comprise corresponding recesses through which the receiving tubes project, so that in the stacked state the ballast cylinders can be engaged with the receiving tubes from above, for example in combination with a rotary movement of the upper carriage. Such receiving tubes are subjected to high loads and sometimes considerable transverse forces during crane operation and therefore usually have stiffening elements in the form of stiffening plates that are welded to the counterweight base plate and the receiving tube. Instead of cylindrical receiving tubes, flat connection elements can also be used, which also frequently have corresponding stiffeners to safely withstand the transverse forces occurring during an inclined position or when cornering.

Connecting the counterweight device to the upper carriage is generally a challenge—not least because of the considerable weight of the counterweight device and the dynamic forces that sometimes occur during crane operation. On the one hand, the counterweight device must be held securely and stably on the upper carriage. For this purpose, it is known, for example, that the ballast cylinders hold the counterweight device on the upper carriage during crane operation. On the other hand, the connection of the counterweight device to the upper carriage should be uncomplicated and quick to perform.

To assemble the counterweight device, it is usually placed on a support area on the undercarriage and the counterweight elements are stacked on the counterweight base plate. The upper carriage rotates with its ballast device over the stacked counterweight device and the ballast cylinders pull it to the upper carriage by the connection elements.

This known mounting system limits the size of the mountable volume of the counterweight device. The upper support surface on the undercarriage that receives the counterweight device for mounting determines the lower limit of the mountable volume of the counterweight device. The plane through the lowest point on the ballast device determines the upper limit of the mountable volume of the counterweight device. If the counterweight device has a height that exceeds this distance, the upper carriage collides with the stacked counterweight device.

Furthermore, the counterweight device cannot extend arbitrarily far from the vertical axis of rotation of the upper carriage. Here, the undercarriage typically has other components such as a cab, engine housing, exhaust aftertreatment components or the like, so the counterweight device cannot extend in this area. The counterweight device also cannot extend closer to the vertical axis of rotation of the upper carriage because the steel structure of the upper carriage is located there.

If the mass of the counterweight is now to be increased further, this could only be achieved by increasing the specific weight of the counterweight elements while maintaining the same volume. However, this makes the production and provision of the counterweight elements complex and expensive.

DE 20 2014 008 661 U1 describes how the distance between the ballast cylinders and thus the center of gravity of the counterweight can be changed in order to increase the counterweight moment. This distance can be fixed before the counterweight is set up. However, the disadvantage of this solution is that the counterweight radius cannot be changed during crane operation. As a result, the counterweight radius cannot be adapted to the prevailing space conditions on the construction site, for example, during a specific rotation movement. Furthermore, an additional tipping criterion arises, especially in the case of mobile cranes with a variable support base. If there is only limited space available on the construction site, mobile cranes with such a variable outrigger base are often set up with the outrigger pushed far out in the direction of the lifting work. This means that there is a large support base in this direction, but the support in the opposite direction (to the rear) is usually only slightly extended, so that there is a risk of “tipping backwards” after the load has been set down.

Other solutions, such as that of DE 10 2016 009 013 A1, use pivoting counterweight base plates. However, the assembly of such counterweight devices turns out to be complex, since the counterweight devices carry their own ballast cylinders to press themselves against the upper carriage from below. Thus, a hydraulic connection to the ballast cylinders of the counterweight device must be established before the counterweight is set up. Furthermore, a secure, stable mounting of the counterweight device on the ballast cylinders must be ensured so that it does not tilt when pressed upwards.

Finally, the CO₂ balance sheet is also a relevant factor nowadays. Here, the transport of heavy counterweight elements is a disadvantageous component. Heavy counterweight elements quickly overload transport vehicles, which means that additional transport vehicles have to be used, thus worsening the CO 2 balance sheet.

Against this background, the present disclosure is based on the object of providing a counterweight device for generic mobile cranes, which can be easily and safely attached to the upper carriage and with which a high counterweight moment can be generated during operation.

According to the disclosure, this object is achieved by a mobile crane, a counterweight device, and a method as described herein. Advantageous embodiments of the disclosure result from the following description.

Accordingly, on the one hand a mobile crane is proposed which comprises a mobile undercarriage, an upper carriage rotatably mounted on the undercarriage, and a counterweight device which can be coupled to the upper carriage. In particular, a boom, for example a telescopic boom, is articulated to the upper carriage in a lulling manner. The counterweight device comprises a counterweight base plate and at least one connection element for lifting the counterweight device and for coupling the counterweight device to the upper carriage. The at least one connecting member is connected to the counterweight base plate and extends substantially perpendicular to the counterweight base plate. When in the following, for the sake of simplicity, only “the connection element” is referred to, this is to be understood as the at least one connection element, i.e. including any further connection elements that may be present.

According to the disclosure, the counterweight device comprises a carrier plate which can be connected to the at least one connection element above the counterweight base plate. “Above” here refers to a situation in which the counterweight base plate (or the mobile crane) is placed on a horizontal base and the connection element extends vertically upwards. When the counterweight device is mounted, the carrier plate is consequently located between the counterweight base plate and the connection point of the connection element with the upper carriage.

According to the disclosure, at least one pivot beam is mounted on the carrier plate so as to pivot about a vertical axis, wherein at least one first counterweight elements is stackable on the pivot beam. In the present context, counterweight elements which are supported or stacked on pivot beams are referred to as “first counterweight elements”. The pivot beam thus serves, as it were, as an additional base plate which can be pivoted relative to the carrier plate and on which further (first) counterweight elements or a counterweight stack can be arranged. By pivoting about the vertical axis (this again refers to a situation with a level, horizontal base), the distance of the first counterweight element mounted on the pivoting carrier from the axis of rotation of the upper carriage can be changed. This allows, for example, the total counterweight moment generated by the counterweight device to be increased or decreased, or the space occupied by the counterweight device to be reduced, in order to be able to rotate the upper carriage in confined spaces.

The counterweight stack that can be stored on the pivot beam (this can also comprise only a single first counterweight element, but preferably several first counterweight elements) is not limited in the upward direction, so that the total weight or volume of the counterweight can be increased without causing problems during assembly or disassembly of the counterweight device.

At the same time, the counterweight device is securely and stably mounted via the at least one connection element, by means of which the counterweight base plate, any additional counterweight elements placed thereon, and the carrier plate with the pivot beam and the counterweight mounted thereon can be lifted together onto the upper carriage and mounted thereon. This can preferably be done via ballast cylinders attached to the upper carriage, which pull the counterweight device upwards on the at least one connection element. This simplifies the assembly or disassembly process compared to solutions in which the ballast cylinders are part of the counterweight device.

Alternatively, however, it is also conceivable that one or more ballast cylinders are arranged on the undercarriage or on or in the at least one connection element and press part of the counterweight device (e.g. fastening means for mounting the counterweight device on the upper carriage or the at least one connection element, which has such a fastening means) or the entire counterweight device upwards in the direction of the upper carriage, where the counterweight device can be connected to the upper carriage (for example to a ballast frame). Subsequently, the at least one ballast cylinder can be retracted again. This possibility (an upward pushing by means of at least one ballast cylinder) is also encompassed by said “lifting” of the counterweight device. Moreover, the fact that the connection element is “connected” to the counterweight base plate does not preclude it from being moved relative to the counterweight base plate—for example, by a ballast cylinder.

Thus, the at least one connection element represents a pull member and connection element for the entire counterweight device combined in one element, which reduces the number of components, facilitates operation or assembly, and ensures a stable connection of the various components.

The at least one connection element can be formed in one piece. This eliminates the need for complex welded connections with other components, which simplifies the manufacturing process.

Preferably, the at least one connection element is formed as a one-piece sheet metal structure with a particularly substantially flat shape. Such a sheet metal construction is easier to manufacture than, for example, a cylindrical receiving tube and can be manufactured with a suitable thickness to withstand the various loads acting along and transversely to its longitudinal axis. The at least one connection element can optionally be manufactured as a flame-cut part from an easily procurable, inexpensive thick plate with large tolerances. The contour may be fired and machined in some places.

In one possible embodiment, it is provided that the at least one connection element is firmly connected, in particular welded, to the counterweight base plate. The connection element can be welded to an upper side of the counterweight base plate or held immovably in a recess in the counterweight base plate and firmly connected to the counterweight base plate. The connection between the connection element and the counterweight base plate, in particular the weld seam, is configured in such a way that it can withstand sufficient loads, in particular with regard to transverse forces that can occur, for example, when the mobile crane is tilted or cornering.

Alternatively, the at least one connection element may be received in a recess of the counterweight base plate, wherein preferably there is no completely fixed connection, but movement of the connection element along its longitudinal axis relative to the counterweight base plate is possible within certain limits. In particular, the connecting member may have a base portion, a middle portion and a coupling portion, wherein the base portion is received in the recess of the counterweight base plate and the middle portion projects through an opening of the recess. The end of the coupling member opposite the counterweight base plate may have a coupling portion, which is for coupling to the upper carriage. The counterweight base plate may rest on a resting surface of the base portion on the connecting member, wherein the recess preferably allows movement of the base portion within the recess in the longitudinal direction of the connecting member. The recess may be open to an underside of the counterweight base plate and optionally covered by a cover plate.

Due to this degree of freedom of movement, which results from the certain displaceability of the base section within the recess, in the raised state the counterweight base plate (as well as any counterweight elements stacked on it) rests completely on the at least one connection element and the connection element does not touch the cover. The cover is therefore not loaded in this state. Only in a state supported on the floor or a support area does the weight of the connection element bear on the cover. Due to the mobility of the connection element within the recess and the preferably non-existing connection to the cover, the latter is not laterally loaded when the counterweight device is tilted or when transverse forces occur; instead, at most a slight frictional connection or frictional load may act.

In another possible embodiment, a ballast device is provided on the upper carriage, which is set up to lift the counterweight device from a support area of the undercarriage and support it on the latter. In particular, the counterweight device can be detachably connected to the ballast device, i.e. the ballast device preferably performs a dual function: lifting and lowering the counterweight device and attaching it to the upper carriage.

Preferably, the at least one connection element comprises a coupling portion at an end opposite the counterweight base plate (i.e. facing the upper carriage or the ballast device), via which a mechanical coupling with the ballast device can be established. The coupling portion may comprise a receptacle into which a lifting device of the ballast device, in particular a ballast cylinder, can be inserted in order to establish a connection for lifting the counterweight device.

In another possible embodiment, it is provided that the ballast device comprises at least one hydraulic ballast cylinder, which can be releasably engaged with the coupling portion or its receptacle of the at least one connection element. In particular, the ballast cylinder comprises a piston rod which is extendable downwardly from the ballast device and couplable to the coupling portion of the connecting member. Preferably, two or more ballast cylinders and a corresponding number of connecting members are provided.

Preferably, the ballast device comprises a ballast frame, which preferably supports the ballast cylinder or cylinders. The ballast frame can have one or more bending beams to which or in which the at least one connection element can be fastened.

Preferably, the coupling portion of the connecting means comprises a receptacle in the form of an upwardly open recess into which a coupling piece of the ballast cylinder can be inserted, in particular by rotating the upper carriage about its vertical axis of rotation. The coupling piece can be part of the piston rod of the ballast cylinder or a component connected to it. The coupling piece may be lockable in the recess, for example by means of a specially provided locking device. Alternatively or additionally, the locking may simply result from a mechanical stop which blocks further movement of the coupling piece relative to the coupling portion.

The receptacle of the coupling portion can be configured in a manner known per se so as to permit lateral insertion (e.g. following a circular motion) of the ballast cylinder and, in the connected state (i.e. in the mounting position in which the counterweight device can be raised by retracting the ballast cylinder or cylinders), to positively block movement of the ballast cylinder out of the recess in the vertical direction. In the raised state, the counterweight device can rest on or hang from the coupling piece of the at least one ballast cylinder via the recess of the at least one connection element.

Alternatively to the described possibility that the counterweight device is lifted at the at least one connection element via the at least one ballast cylinder arranged at the upper carriage, the principle reversal would also be conceivable, in which at least one ballast cylinder is arranged at or in the at least one connection element and lifts this completely or a part thereof (which has the said fastening means) to the upper carriage in order to be able to connect the connection element or the lifted part thereof to the upper carriage. In this case, the at least one ballast cylinder can preferably lift the at least one connection element relative to the counterweight base plate. After assembly to the upper carriage, the counterweight base plate can be lifted to the upper carriage by retracting the at least one ballast cylinder. It is likewise conceivable that the at least one ballast cylinder is arranged on the undercarriage and lifts the entire counterweight device to the upper carriage, where it is then connected to the upper carriage via the at least one connection element.

In a further possible embodiment, at least one second counterweight element is provided, which can be placed or stacked on the counterweight base plate and comprises at least one recess through which the at least one connection element projects in the supported state. Presently, counterweight elements which are directly supported or stacked on the counterweight base plate are referred to as “second counterweight elements”. The second counterweight element is in particular plate-shaped. Several second counterweight elements or plates can be provided, which can be stacked on the counterweight base plate.

The counterweight base plate represents in particular the lowest counterweight element of the counterweight device, on which all possibly additionally provided second counterweight elements can be stacked. The recesses of all second counterweight elements overlap at least partially so that the at least one connection element can project through the stack and is accessible from above.

Above this stack of counterweight base plate and possibly the one or more second counterweight elements, the carrier plate is connected to the connection element. In other words, the second counterweight element (or the stack of several second counterweight elements) is arranged between the counterweight base plate and the carrier plate in the ballasted state. In particular, the second counterweight element is not tensioned during ballasting.

More than one connection element is preferably provided for stable mounting of the counterweight elements and connection of the counterweight device to the upper carriage. In a further possible embodiment, the counterweight device therefore comprises at least two connection elements spaced apart from one another and connected to the counterweight base plate. Preferably, exactly two connection elements are provided, although more than two connection elements may also be provided. In particular, the connection elements are arranged at the same distance from the center of gravity or from a center line of the counterweight base plate (which is preferably aligned parallel to the longitudinal axis of the upper carriage). This can result in an overall mirror-symmetrical arrangement of counterweight base plate and connection elements.

The connection elements can be arranged rotated against each other (each about a vertical axis). This may be due to the fact that the ballast cylinders are moved along a circular path by rotating the upper carriage in order to establish the coupling with the connection elements. In this case, the connection elements can be configured as flat sheet metal structures that are not aligned parallel to each other, but inclined at a certain angle to each other. Preferably, however, the connection elements are not rotated relative to one another, but are arranged parallel to one another. This simplifies the manufacture of the counterweight base plate as well as the carrier plate and the second counterweight element.

The counterweight base plate and/or the carrier plate and/or the at least one pivot beam and/or the at least one first counterweight element and/or the at least one second counterweight element are each formed in particular by a box, in particular a steel box, into which weights, in particular solid metal blocks, are inserted during manufacture. The box is then filled with a binder and brought to the desired weight. The counterweights produced in this way are intended to be inexpensive, robust and heavy. The binder may have a lower specific gravity than the metal inserted. Thus, large and solid metal components are advantageous. The more complicated the shape of the counterweight base plate or counterweight elements and the more bulges and interruptions there are, the more difficult it is to manufacture or design the steel box with solid weights or blocks. The fact that the connection elements are preferably arranged parallel to one another results in geometrically ideal areas for filling the respective steel boxes with solid weights during production.

Alternatively, one or more of the plates or elements mentioned in the previous paragraph can be provided in cast iron design. Overall, the space available in the area of these plates or elements is small, so that the greatest possible specific weight should be used. Also, the connection element as well as, if applicable, the counterweight base plate must introduce a large force (weight force of the carrier plate, of the at least one pivot beam as well as of the at least one first counterweight element accommodated thereon) into the undercarriage without suffering any damage themselves.

The carrier plate and the at least one pivot beam can alternatively have a concrete filling. This results in a lower weight of these components, so that the counterweight device (in particular without first counterweight elements) can be moved as a whole, i.e. as a transport unit, in certain designs of these components. This eliminates the need for time-consuming assembly and disassembly of the carrier plate and, if necessary, the second counterweight element. In addition, the counterweight device can thus also be picked up by a more distant transport vehicle. Furthermore, a concrete filling represents a comparatively low-cost solution. It may be envisaged that the carrier plate and the pivot beam have the same weight (e.g. 10 t or 4 t) or a different weight (e.g. carrier plate: 10 t, pivot beam: 4 t).

In the case of the parallel arrangement of the connecting means, it should be noted that the ballast cylinders move in particular on a circular path when the counterweight device is mounted. This circumstance must be taken into account accordingly when designing the connecting means or the coupling portions of the connecting means. This can be done, for example, by means of sufficiently large receptacles for the coupling portions. Alternatively or additionally, arc-shaped receptacles or other solutions would also be conceivable.

Preferably, at least two pivot beams are mounted on the carrier plate so as to pivot about a vertical axis in each case, wherein at least one first counterweight element, preferably a counterweight stack in each case, can be mounted on each of the pivot beams. The pivot beams can be pivoted independently of one another. As a result, the space occupied by the counterweight device can be flexibly adapted to the respective application situation, for example with regard to confined space conditions or obstacles or with regard to the counterweight moment generated. A mechanical coupling of several pivot beams with each other can also be considered in order to enable a synchronous pivoting movement of all pivot beams. This means that the overall center of gravity always moves along a defined line.

Preferably, the pivot beams are arranged symmetrically to a center plane of the upper carriage extending through the vertical axis of rotation of the upper carriage in the set-up state. Exactly two pivot beams can be provided, although a configuration with more than two pivot beams is also conceivable, which can, for example, be mechanically coupled to one another on each side of the aforementioned center plane.

In a further possible embodiment, it is provided that the at least one connection element has a support surface via which the counterweight base plate rests on the connection element at least in the absence of an inclined position of the mobile crane and introduces its weight force into the latter. The support surface may be a continuous surface or several partial surfaces. The support surface or the possibly several partial surfaces can/may comprise flat and/or beveled and/or curved areas. Preferably, at least two support surfaces are provided on opposite sides of the connection element. This allows the counterweight base plate to be supported stably on the connection element.

Alternatively or additionally, the at least one connection element may comprise a centering means by means of which the counterweight device can be positioned on the upper carriage in a mounting position. The centering means interacts in particular with a counter-centering means on the upper carriage and ensures automatic positioning of the counterweight device during lifting onto the upper carriage. Centering the counterweight device in an intended mounting position on the upper carriage facilitates its attachment.

In this context, the upper carriage preferably comprises a corresponding counter-centering means which is configured to automatically position the counterweight device in a mounting position in which it can be connected to the upper carriage, in particular to said ballast device, by interacting with the centering means of the connection element when the counterweight device is lifted. Preferably, the centering means is formed as an element extending substantially in the longitudinal direction of the connection element, for example as a projection. Accordingly, the counter-centering means forms a recess into which the centering means enters when the counterweight device is lifted. However, the reverse case (centering means as a recess and counter-centering means as a projection or the like projecting downward from the upper carriage) is also conceivable. The centering means preferably comprises at least one beveled surface or chamfer, i.e. it may have one or more beveled surfaces, for example in one or two directions, to facilitate the engagement of centering means and counter-centering means. A conical shape with a circumferential chamfer of the centering means or counter-centering means is also possible.

Alternatively or additionally, the at least one connection element may comprise a fastening means via which the counterweight device can be detachably connected to the upper carriage in a mounting position (in particular the mounting position reached by the aforementioned pre-centering). In particular, the counterweight device is thus not held on the upper carriage by one or more ballast cylinders during crane operation, but a separate connection is provided which is established via the fastening means of the at least one connection element and, in particular, via corresponding connecting means on the upper carriage. This allows the counterweight device, including the carrier plate connected to the connection element, to be securely and stably fastened to the upper carriage so that any ballast cylinders provided are relieved of load after lifting and fastening.

Preferably, the at least one connection element comprises both a centering means and a fastening means. The at least one connection element thus fulfills multiple functions: on the one hand, it serves to lift and set down the entire counterweight device and, on the other hand, it ensures correct positioning of the counterweight device on the upper carriage for the purpose of establishing a detachable connection. The latter function, namely the fastening of the counterweight device to the upper carriage, is also performed by the at least one connection element via its fastening means. Thus, the at least one connection element represents a pull element, centering element and connection element combined in one, which reduces the number of components and facilitates operation. Preferably, all these functions are combined in a single unit, in particular without complex welded-on assemblies.

The connection element may comprise a slinging element for attaching a slinging means (e.g. a chain or a rope) of a hoist for lifting the counterweight base plate. This allows the counterweight base plate together with the connection element(s) to be lifted by an auxiliary crane or the mobile crane to be set up itself and positioned, for example, on a support area of the undercarriage. Preferably, the slinging element is formed by a recess in the connection element. Hook elements, projections or the like are also conceivable in order to be able to fasten the slinging means.

Preferably, the counterweight base plate comprises at least one support centering means on the underside thereof for positioning the counterweight device on the support area of the undercarriage. Preferably, the support area comprises at least one corresponding counter support centering means engageable with the support centering means for correctly positioning the counterweight device on the undercarriage. This allows the counterweight device to be aligned in a correct position required for smooth reception or coupling with the ballast device, in particular smooth coupling of the ballast cylinders. The support centering means may be a recess and the counter-support centering means may be a projection, pin or other protruding element insertable into the recess (or vice versa).

In a further possible embodiment, provision is made for that the at least one pivot beam can be continuously pivoted relative to the carrier plate via a pivot drive. Such a pivot drive is necessary in particular because the bearing forces in the vertical pivot bearing are very high. The pivot drive can preferably be a hydraulic cylinder but also any other actuator such as an electric drive. Preferably, the pivot drive is hinged to both the carrier plate and the pivot beam. However, the pivot drive does not necessarily have to connect the carrier plate and the pivot beam directly to each other. A lever system would also be possible in order to make optimum use of the geometry.

Preferably, the pivot angle of the pivot beam is detected by at least one sensor and made available, for example, to a crane control system for evaluation. In this way, the control system is also able to take intermediate positions into account in the crane monitoring.

In a further possible embodiment, it is provided that the at least one connection element comprises a supporting surface on which the carrier plate can be supported, in particular in such a way that the weight force of the supported carrier plate is introduced only into the at least one connection element and not into the counterweight base plate or into a second counterweight element supported thereon. The supporting surface may be a continuous surface or a plurality of partial surfaces. The support surface or, as the case may be, the plurality of partial surfaces may comprise flat and/or beveled and/or curved areas. Preferably, at least two support surfaces are provided on opposite sides of the connection element, particularly preferably four support surfaces, which are distributed in particular around the connection element. This allows the carrier plate to be stably supported on the connection element. The carrier plate may have a corresponding mating support surface which rests on the support surface of the connection element.

In a further possible embodiment, it is provided that the carrier plate comprises at least one recess through which the at least one connection element projects in the connected state. The carrier plate is thus pushed or “threaded” onto the at least one connection element from above and, in particular, let down until it rests on the support surface of the connection element.

The end of the connection element projecting through the carrier plate or protruding from the top of the carrier plate preferably comprises a fastening means via which the counterweight device can be detachably connected to the upper carriage. This allows the entire counterweight device to be connected, in particular bolted, to corresponding connecting means of the upper carriage after it has been attached to the upper carriage.

In particular, the connecting means comprises the coupling portion described above for coupling with a corresponding coupling piece of a ballast cylinder. Preferably, the coupling portion or its receptacle is arranged such that, in the connected state, it lies within the recess of the carrier plate. Preferably, the recess of at least the carrier plate is formed in such a way that the coupling piece of the ballast cylinder can be positioned next to the coupling portion of the connection element within the recess and can be retracted into the coupling portion or its receptacle by rotating the upper carriage about its vertical axis of rotation. In the process, the ballast cylinder describes a circular path and moves laterally into the coupling portion. The recess in the carrier plate must therefore be correspondingly wider to permit such a circular movement when coupling the ballast cylinder to the connection element. The second counterweight element(s), which may be located underneath, can, on the other hand, be of a different design so that essentially only the connection element fits through it.

The recess of the carrier plate may comprise a mechanical stop against which the coupling piece of the ballast cylinder abuts in a locking position in which the ballast cylinder and the connection element are correctly coupled to each other, in which the counterweight device can thus be lifted by the at least one ballast cylinder. The stop may be formed by a wall of the recess itself, resulting in a particularly simple configuration. Alternatively, the stop can also be implemented by a separate component arranged in the recess.

In a further possible embodiment, it is provided that the carrier plate and the at least one connection element each comprise connecting means for establishing a releasable connection, in particular a bolt connection, with one another. These connecting means, which serve to establish a fixed connection, i.e. one that does not permit any relative movement (but is nevertheless detachable), between the connection element and the carrier plate, are provided in particular in addition to the previously described support and counter support surfaces of the connection element and the carrier plate. The carrier plate is merely placed on the connection element via these support and counter support surfaces. However, the connection between the connection element and the carrier plate, which is actually intended for operation and the motionless transmission of the forces and moments that occur, is produced by the connecting means. The connection element may comprise one or more bolt receptacles as connecting means, which are brought into overlap with corresponding bolt receptacles in the carrier plate before corresponding bolts are set.

Optionally, it can be provided that the at least one pivot beam can be removed from the carrier plate for transport. The mobile crane may comprise at least one receptacle on the undercarriage and/or on the upper carriage for storing the at least one pivot beam during transport.

In another possible embodiment, it is preferably provided that the at least one first counterweight element has a substantially triangular basic shape or cross-sectional area (in plan view). This allows the center of gravity of the movable part of the counterweight device (i.e., pivot beam together with the first counterweight element or elements stacked thereon) to move further away from the axis of rotation of the upper carriage about the undercarriage than the outermost point of the counterweight device, in comparison. Thus, the outermost point of the counterweight device forming the pivot radius or ballast radius of the upper carriage, which determines the space required on the construction site, is comparatively less enlarged than the center of gravity of the moving part of the counterweight device, which is shifted outward to generate the higher counterweight moment.

For handling the first counterweight elements and, if necessary, the pivot beam, an assembly device can optionally be used, as known from DE 20 2004 009 497 U1. For this purpose, the first counterweight elements can be configured accordingly and in particular each have a corresponding central recess into which the mandrel-shaped mounting device can be inserted.

The pivot beam together with the counterweight element(s) can be moved by lateral pivoting from a first position resting against the carrier plate into a second position, the center of gravity of the arrangement of pivot beam and counterweight element(s) being at a greater distance from the axis of rotation of the upper carriage in the second position than in the first position. The first position may be characterized by full retraction of a corresponding pivot drive. The second position may be characterized by a pivot angle of the at least one pivot beam relative to the first position of 30-60°, preferably 40-50°.

In the second position and with the connection between the upper carriage and the counterweight device released, the upper carriage can rotate freely relative to the counterweight device without colliding with it. This is particularly relevant for self-assembly of the counterweight mounted on the pivot beam. In order for the mobile crane to be able to support one or more first counterweight elements on the pivot beam with its own boom, the upper carriage must be able to rotate freely without colliding with the counterweight device supported on the undercarriage. For this purpose, it may be necessary to establish a temporary electrical and/or hydraulic connection to the counterweight device in order to operate the pivot drive and move the pivot beam to the second position. The upper carriage can then be rotated freely to receive a first counterweight element and place it on the pivot beam without colliding with the counterweight device.

The pivot beam can be moved by further pivoting to a third position in which the center of gravity of the arrangement of pivot beam and counterweight element(s) is at an even greater distance from the axis of rotation of the upper carriage than in the second position. The third position may be characterized by complete extension of the pivot drive. In particular, the second position may be considered to be any intermediate position between the first and third positions in which no collision with the at least one first counterweight mounted on the pivot beam occurs during a rotation of the upper carriage relative to the counterweight device. In the third position, the angle of the at least one pivot beam relative to the first position may be more than 100°, for example 120-150°, preferably 130-140°.

The counterweight base plate together with the connection element(s) may comprise a structure that is mirror-symmetrical to a central axis extending through the center of the counterweight device.

The counterweight base plate and/or the at least one second counterweight element that can be placed thereon can have a curved shape in plan view, i.e. a shape that deviates from a rectangle.

Preferably, the carrier plate and the at least one connection element are dimensioned, in particular with regard to their height, such that the counterweight device in the connected state with the upper carriage does not collide with an interference area, in particular an engine housing and/or a driver's cab and/or an exhaust gas aftertreatment device, of the undercarriage during a rotation of the upper carriage. In particular, a lowermost edge of the pivot beam in the connected state lies above an uppermost edge of the interference area. The ballast plate and any second counterweight elements mounted thereon, on the other hand, can lie partially below the uppermost edge of the interference area, since their outer edges are in particular at a smaller distance from the axis of rotation of the upper carriage than the radially outer edges of the pivot beam, at least in a fully extended (third) position.

The pivot drive allows the at least one pivot beam to be adjusted, in particular continuously, and to assume any pivot angle between the minimum angle (first position) and a maximum pivot angle. This allows the ballast radius of the counterweight device to be infinitely adjusted, for example in a range of 0-135° (although the range can of course also be larger or smaller), which enables very flexible crane use.

Because the ballast radius can be increased during crane operation, beyond the space available on the undercarriage (when mounted on the upper carriage, the counterweight device is located above the undercarriage components, such as an engine housing, and thus cannot collide with them), the counterweight device can be configured in such a way that, in the first position (pivot beam applied to the carrier plate), it has a smaller distance along the longitudinal axis of the undercarriage than was the case with known counterweight devices (where the counterweight device had to have the greatest possible extension in order to maximize the ballast radius). As a result, the counterweight device according to the disclosure provides additional installation space on the undercarriage since the counterweight device mounted on the undercarriage does not take up as much space. This installation space can be used, for example, to arrange additional components on the undercarriage or to reduce the undercarriage length and thus increase the maneuverability of the undercarriage.

The disclosure further relates to a counterweight device for a mobile crane according to the disclosure. Obviously, the same advantages and features arise as for the mobile crane according to the disclosure, which is why a repetitive description is dispensed with. Preferably, the counterweight device further comprises at least a first counterweight element which can be supported or stacked on the pivot beam. Alternatively or additionally, the counterweight device may further comprise at least a second counterweight element that is supportable or stackable on the counterweight base plate.

The disclosure further relates to a method for mounting the counterweight device according to the disclosure on the upper carriage of a mobile crane according to the disclosure. The method comprises at least the following steps:
placing the counterweight base plate on a support area of the undercarriage, in particular by means of a boom attached to the upper carriage of the mobile crane,
connecting the carrier plate to the at least one connection element,
lifting the counterweight device via the at least one connection element, in particular by coupling at least one ballast cylinder of the upper carriage to the at least one connection element and subsequently retracting the ballast cylinder,
establishing a connection, in particular a bolt connection, between the at least one connection element and the upper carriage. Preferably, a connection is made between a fastening means of the connection element projecting through the carrier plate and a ballast device of the upper carriage.

Obviously, the same advantages and features arise here as for the mobile crane according to the disclosure, which is why a repetitive description is dispensed with. In particular, reference is made to the possible embodiments and optional features discussed in the context of the mobile crane according to the disclosure, which apply analogously to the process according to the disclosure.

In one possible embodiment of the method, it is provided that the step of connecting the carrier plate to the at least one connection element comprises the following steps:
bringing the carrier plate to the at least one connection element, in particular by means of the boom of the mobile crane,
inserting the at least one connection element into the corresponding recess of the carrier plate,
supporting the carrier plate on the support surface of the at least one connection element described above, so that the carrier plate rests only on the connection element or the support surface,
connecting the carrier plate to the at least one connection element via the connecting means, in particular by producing a bolt connection.

If the at least one pivot beam has been removed from the carrier plate for transport, the method may further comprise the step of connecting the pivot beam to the carrier plate.

Optionally, the method may comprise supporting or stacking at least one first counterweight element on the pivot beam, prior to lifting the counterweight device via the at least one connection element. This may be done via an external lifting device (e.g., an auxiliary crane). In this case, the pivot beam does not necessarily have to be pivoted out. Preferably, however, stacking is carried out in self-assembly by the mobile crane itself. This means that it must be able to rotate relative to the carrier plate or pivot beam. In this case, the process may still include the step of establishing a hydraulic and/or electrical connection of the mobile crane to a pivot drive of the carrier plate.

The pivot drive is then actuated to pivot the at least one pivot beam out into a position in which the upper carriage does not collide with it during rotation. For this purpose, the at least one pivot beam is pivoted through a certain angle, whereby the angle can be, for example, between 30° and 60°, preferably between 40° and 50°. In this case, the counterweight device rests on the undercarriage and the pivot beams are pivoted out (second position) to such an extent that the upper carriage can rotate freely. Subsequently, the at least one first counterweight element can be placed on the pivot beam, i.e. the crane can now independently stack the at least one counterweight element or a tower of counterweight elements on the pivot beam. During this process, the entire counterweight device remains only lying on the undercarriage and does not tilt. Afterwards, the electrical and/or hydraulic connection can be disconnected again, with the pivot beam preferably being pivoted back in beforehand. The disconnection can take place before or after the counterweight device is lifted and attached to the upper carriage. Preferably, before the counterweight device is lifted by means of the at least one ballast cylinder, the at least one pivot beam is pivoted back into the first position.

To dismantle the counterweight device, the above steps can be carried out in reverse order (method for dismantling the counterweight device according to the disclosure from the upper carriage of a mobile crane according to the disclosure).

### BRIEF DESCRIPTION OF THE DRAWINGS

Further features, details and advantages of the disclosure will be apparent from the examples of embodiments explained below with reference to the figures. The Figures show in:

FIG. 1: a partial side view of a mobile crane known from the prior art;

FIG. 2: a perspective view of the counterweight device according to the disclosure in accordance with a preferred embodiment;

FIG. 3: a partial view of the mobile crane according to the disclosure in accordance with a preferred embodiment with the counterweight device mounted in a perspective view;

FIG. 4: a plan view of the mobile crane with the counterweight device placed on the undercarriage in a first position;

FIG. 5: a side view of the mobile crane shown in FIG. 4;

FIG. 6: a plan view of the mobile crane with the counterweight device placed on the undercarriage in a second position;

FIG. 7: a side view of the mobile crane shown in FIG. 6;

FIG. 8: a plan view of the mobile crane with the counterweight device mounted on the upper carriage in a third position;

FIG. 9: a side view of the mobile crane shown in FIG. 8;

FIG. 10: a side view of the mobile crane with the counterweight device uncoupled from the upper carriage; and

FIG. 11: a sectional view through the articulated connection between the carrier plate and the pivot part along the vertical axis according to an embodiment.

### DETAILED DESCRIPTION

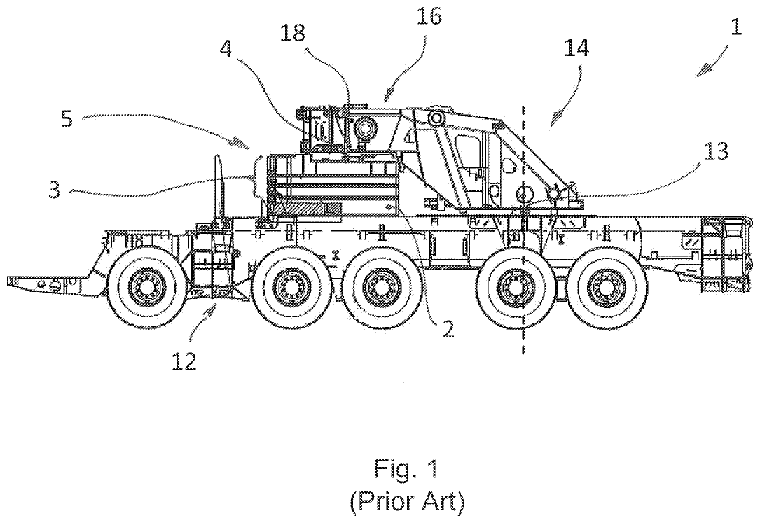

FIG. 1 shows a side view of an example of a mobile crane 1 known from the prior art. The mobile crane 1 comprises an undercarriage 12 with a wheeled undercarriage and an upper carriage 14 mounted on the undercarriage 12 so as to rotate about a vertical axis of rotation 13 by means of a pivot gear. In FIG. 1, only the steel structure of the undercarriage and the upper carriage 12, 14 is shown. An extension arm (not shown), for example a telescopic extension arm, is hinged to the upper carriage 14 so that it can pivot about a horizontal axis. A ballast frame 16 of a ballast device is bolted to the steel structure of the upper carriage 14. The ballast device comprises two hydraulic ballast cylinders 18 to receive from or place on a support area of the undercarriage 12 a counterweight device 5, also referred to as upper carriage ballast, with a counterweight base plate 2 and several counterweight plates 3 stacked thereon. Via connecting means 4, the counterweight device 5 is bolted to the ballast frame 16 after lifting.

Form the mounting of the counterweight device 5, the latter is stacked on the undercarriage 12. The upper carriage 14 rotates with its ballast device over the counterweight device 5 and the ballast cylinders 18 pull it to the upper carriage 14. As explained at the beginning, in this known system the size of the mountable counterweight 5 is limited, both in height (due to the ballast device) and to the rear or front (due to the components of the undercarriage 12 and the dimensions of the upper carriage 14).

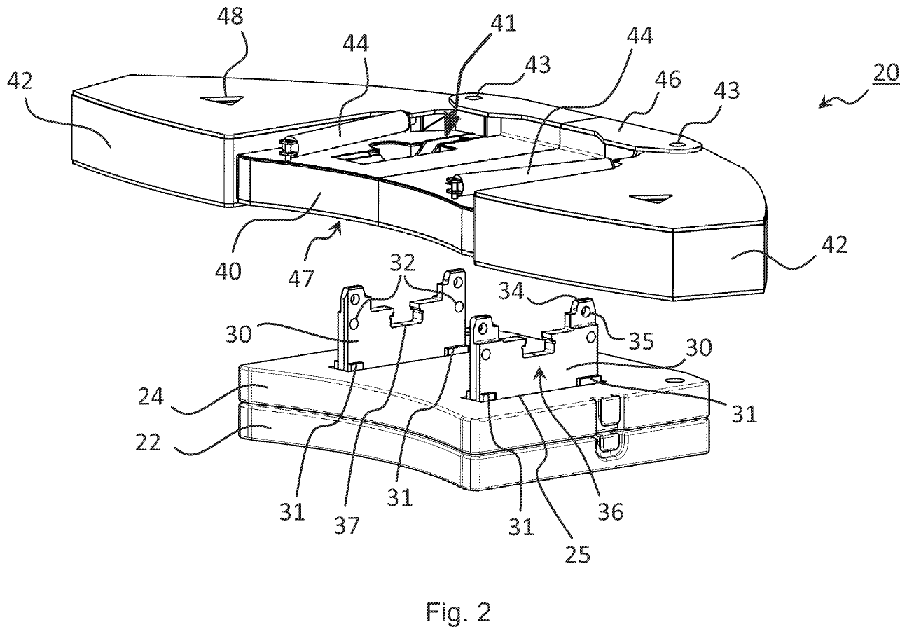

FIG. 2 shows a perspective view of the counterweight device 20 of a mobile crane according to a preferred exemplary embodiment of the present disclosure. The counterweight device 20 comprises a counterweight base plate 22, on which a further plate-shaped counterweight element 24 can be placed in the exemplary embodiment shown here. In other embodiments, multiple plate-shaped counterweight elements 24 could also be stackable on the counterweight base plate 22.

The counterweight device 20 is coupled to the ballast cylinders 18 via connection elements 30 projecting vertically upwards from the counterweight base plate 22, which have coupling portions 36 at their upper ends for reversible coupling to retractable and extendable coupling pieces of the ballast cylinders 18 (which are located in particular on the piston rods of the ballast cylinders 18), as well as fastening means 34 for fastening the counterweight device 20 to the upper carriage 14. The alignment or positioning of the counterweight device in a mounting position on the ballast frame 16 for establishing the connection via the fastening means 34 can be effected via centering means of the connection elements 30, which are shown in the presently discussed exemplary embodiment, but are not provided with reference characters.

As can be seen in FIG. 2, the counterweight base plate 22 has a curved shape (although this is not mandatory) and is connected to two connection elements 30 which project vertically upwards from the counterweight base plate 22. The second counterweight element 24 is also plate-shaped and curved, and has corresponding recesses 25 through which the connection elements 30 project. The second counterweight element 24 is thus supported on the counterweight base plate 22 from above, and is thereby “threaded” onto the connection elements 30, so that the end regions of the connection elements 30 with the coupling portions 36 and fastening means 34 project above the second counterweight element 24 at the top. In particular, the second counterweight element 24 is not bolted to the connection elements 30, but rests on the counterweight base plate 22.

The connection elements 30, which could also be referred to as connecting swords or simply as swords, are in particular one-piece sheet metal structures which have a flat basic shape and are connected to the counterweight base plate 22. Since the connection elements 30 in particular do not consist of several interconnected parts, but are formed in one piece, there is no need to provide welded joints which are complicated to produce and have correspondingly high requirements.

In the exemplary embodiment shown here, the connection elements 30 are oriented parallel to each other and to the side edges of the counterweight base plate 22 (and the second counterweight element 24). This results in a particularly convenient arrangement which facilitates the manufacture of the counterweight base plate 22 (and the second counterweight element 24). In particular, this is accomplished by filling a steel box with solid metal blocks and then filling with a binder. The parallel arrangement creates geometrically ideal areas for filling the steel box with metal blocks. This allows for easy and inexpensive fabrication. Alternatively, the counterweight base plate 22 and/or the second counterweight element 24 may be made of gray cast iron.

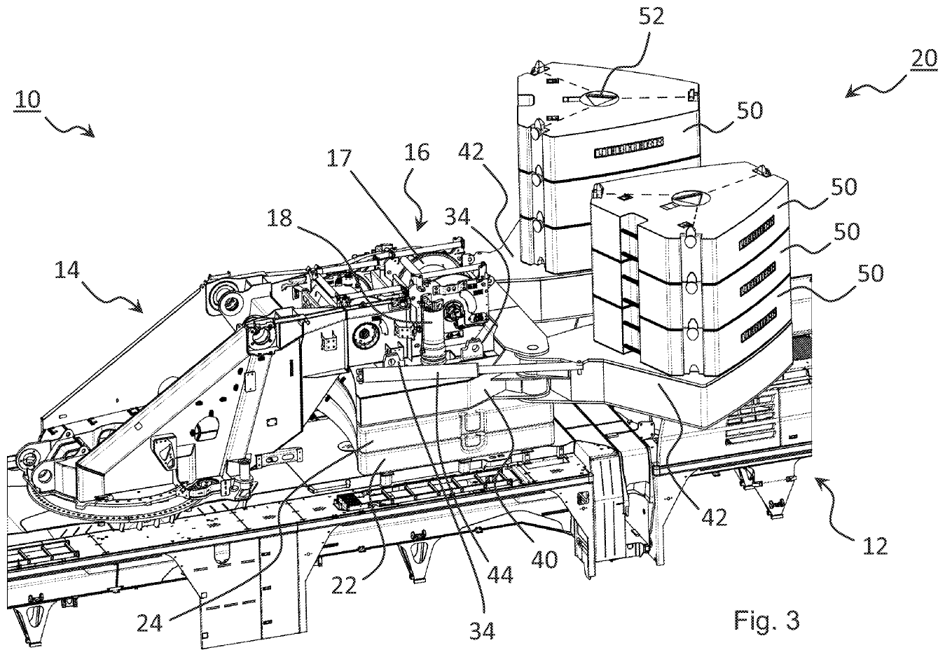

In the embodiment discussed here, the mobile crane 10 according to the disclosure comprises a ballast frame 16 (cf. FIG. 3). Two hydraulic ballast cylinders 18 are accommodated on the ballast frame 16, the piston rods of which can be extended downwards and comprise a coupling piece. The counterweight device 20 can be lifted from a support area on the upper side of the undercarriage 12 to the ballast frame 16 via the ballast cylinders 18 and connected to it. Conversely, the counterweight device 20 can be supported again on the support area via an extension of the ballast cylinders 18 and loaded from there onto a transport vehicle, if necessary, by means of an auxiliary crane or the boom of the mobile crane 10.

The connection elements 30 each comprise, at their end regions spaced from the counterweight base plate 22, a coupling portion 36 for coupling the connection elements 30 and thus the counterweight device 20 to the ballast cylinders 18. When, for the sake of simplicity, only one connection element 30 is referred to in the following, both connection elements 30 are of course meant.

The coupling portion 36 comprises a receptacle arranged centrally on the connection element 30 in the form of an upwardly open, clamp-shaped recess 37, into which a specially shaped (in particular mushroom-shaped) end or coupling piece of the corresponding ballast cylinder 18 can be inserted laterally. In the final position in which the counterweight device 20 can be safely lifted (=locking position), the coupling piece of the ballast cylinder 18 is located completely inside the recess 37 (as is the second ballast cylinder 18 associated with the second connection element 30), which, due to its shape, allows the counterweight device 20 to be lifted in a form-fitting manner by retracting the ballast cylinders 18, since the coupling piece cannot slip upwards out of the recess 37.

The counterweight device 20 according to the disclosure further comprises a carrier plate 40 having two lateral pivot wings or pivot beams 42, each of which is pivotally connected to the carrier plate 40 about a vertical pivot axis 43. The carrier plate 40 has a shape substantially similar to that of the counterweight base plate 22, although this is not necessarily the case. The pivot axes 43 of the pivot beams 42 are located on the side of the carrier plate 40 opposite the upper carriage pivot axis 13 in the set-up state and are mounted in a connection portion 46 of the carrier plate 40 projecting laterally beyond the edge of the carrier plate 40 on both sides.

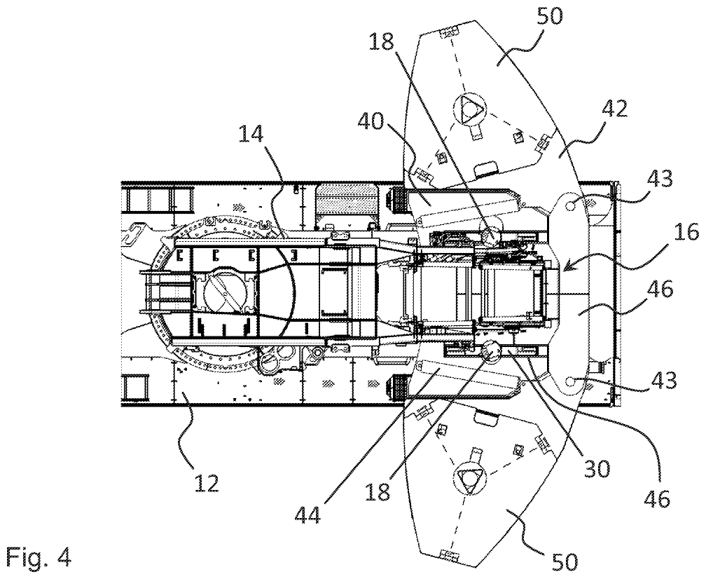

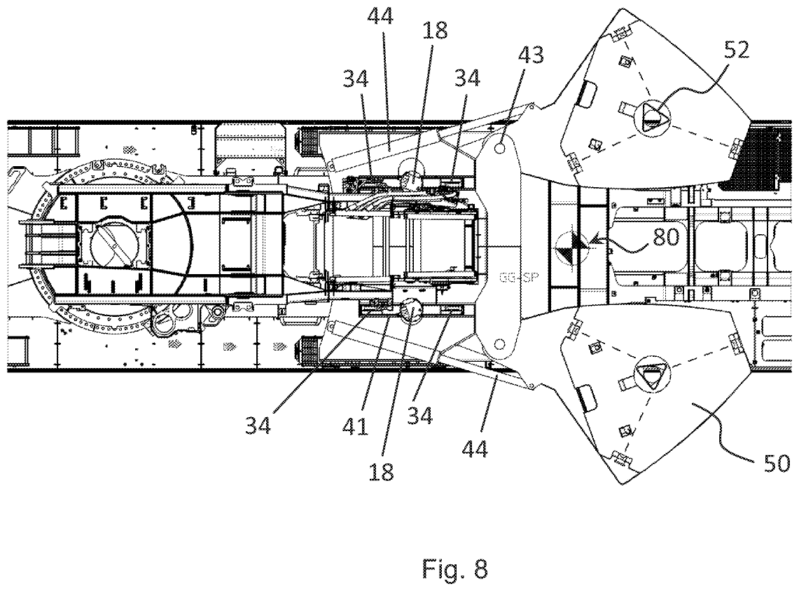

The pivot beams 42 are each movable by means of a pivot drive 44 in the form of a hydraulic cylinder between a first position, in which the hydraulic cylinders 44 are maximally retracted and the pivot beams 42 rest against the carrier plate 40 (cf. FIG. 4), and a third position, in which the hydraulic cylinders 44 are maximally extended and the pivot beams 42 are fully pivoted out (cf. FIG. 8). When the hydraulic cylinders 44 are extended, the pivot carriers 42 pivot out laterally about their vertical axes 43. The hydraulic cylinders 44 are hinged both to the carrier plate 40 and to the respective pivot beams 42.

The carrier plate 40 comprises two recesses 41 for receiving the connection elements 30, which in the shown exemplary embodiment—following the sword shape of the connection elements 30—have an elongated shape or are essentially slot-shaped. The carrier plate 40 is placed from above on the stack of counterweight base plate 22 and second counterweight element 24 (alternatively, the stack could comprise a plurality of second counterweight elements 24), so that the sections of the connection elements 30 projecting from the top of the second counterweight element 24 enter the recesses 41 of the carrier plate. The carrier plate 40 is thus “threaded” onto the connection elements 30 until only their fastening means 34 protrude from the top of the carrier plate 40 (cf. FIG. 3). After being set down, the coupling portions 36 are located in particular within the recesses 41 of the carrier plate 40.

The fastening means 34 of the connection elements 30 are thus accessible after the carrier plate 40 has been fitted, so that the entire counterweight device 20 together with the counterweight base plate 22, second counterweight element 24 and carrier plate 40 (incl. pivot beam 42 and first counterweight elements 50) can be bolted to the ballast frame 16. For this purpose, the fastening means 34 each comprise a bolt receptacle 35. The bolt receptacles 35 of the connection elements 30 are brought together with corresponding bolt receptacles of the ballast frame 16 (and, if applicable, of an adjacent area of the upper carriage steel structure) by lifting the counterweight device 20 and, once the counterweight device 20 is in a mounting position, are bolted thereto. This relieves the ballast cylinders 18 during crane operation.

In the area just above the surface of the second counterweight element 24, the connection elements 30 have a plurality of support surfaces 31 distributed around the connection elements 30. The carrier plate 40 is configured to rest on these support surfaces 31 and therefore does not contact the second counterweight element 24 after it has been set down. Thus, the carrier plate 40 transfers its weight directly into the connection elements 30 via the support surfaces 31 and not into the underlying plates 22, 24. The carrier plate 40 may have counter support surfaces 47 (for example, made of a different material than the rest of the carrier plate 40) on its underside at the corresponding positions, which contact the support surfaces 31.

Further counterweight elements 50 (referred to herein as first counterweight elements 50) are stackable on the pivot beams 42, so that each pivot beam 42 carries its own counterweight stack 50. These are not limited upwardly, since in the connected state they are arranged outside the ballast frame 16 (the latter is arranged between the counterweight stacks cf. FIGS. 4, 6, 8). In the exemplary embodiment shown here, the first counterweight elements 50 have a substantially triangular basic shape, as do the pivot beams 42. Optionally, the first counterweight elements 50 can each have a central recess 52 (cf. FIGS. 3 and 8) into which an elongated mounting device according to DE 20 2004 009 497 U1 can be inserted and locked therein by twisting, in order to be able to lift and move the first counterweight elements with a crane. The pivot beams 42, which are preferably detachable from the carrier plate 40, can also have a corresponding recess 48 (cf. 2) in order to be able to lift or move them with such a mounting device.

By pivoting the pivot beams 42 together with the first counterweight elements 50 stacked on them, the counterweight moment or torque generated by the counterweight device and the ballast radius of the upper carriage 14 can be variably adjusted. The pivoting of the pivot beams 42 via the pivot drives 44 is infinitely variable and can thus be adapted to the load situation currently present. Optionally, at least one sensor can be provided that detects the pivot-out state of the pivot beams 42 and forwards it to a crane control for load moment limitation.

After the carrier plate 40 has been placed in position, it rests on the support surfaces 31 of the connection elements 30 without being firmly connected to them. The carrier plate 40 (and the pivot beams 42) are configured in such a way that they rest stably on the support surfaces 31 in the first position, i.e. the center of gravity of the carrier plate 40 together with the pivot beams 42 is located within the area spanned by the support surfaces 31 in plan view. Thus, the carrier plate 40 does not tilt to the side in the first position. For the fixed or immovable connection of the carrier plate 40 to the connection elements 30, the latter comprise connecting means in the form of bolt receptacles 32 below the fastening means 34. The carrier plate 40 also comprises corresponding connecting means, in particular corresponding bolt receptacles (not shown), through which corresponding bolts can be inserted after being brought together or set down. This can be done manually, with corresponding recesses being provided in particular in order to be able to set the bolts by hand. Alternatively, the carrier plate 40 can have a bolt insertion device by means of which bolts can be automatically pushed through the bolt receptacles of the carrier plate 40 and of the connection elements 30 after setting down, since these bolt receptacles may be difficult to access after setting down. A fixed connection between the carrier plate 40 and the connection elements 30 can thus be established via this bolt connection. This connection can transmit forces and moments without movement in the scaffolded state.

FIG. 3 shows a section of the mobile crane 10 with the counterweight device 20, with only the steel frames of the upper carriage 14 and the undercarriage 12 shown, without any other components such as the undercarriage, boom, etc. The counterweight device 20 is bolted to the ballast frame 16 and the pivot beams 42 are fully extended with their counterweight stacks 50 (third position). The ballast frame 16 carries a winch 17 and is bolted to the steel frame of the upper carriage 14. One of the two ballast cylinders 18 arranged on the side of the ballast frame 16 can be seen, the piston rod of which is retracted. It can also be seen that the fastening means 34 of the connection elements 30 protrude from the top of the carrier plate 40 so that they can be bolted to the ballast frame 16. The carrier plate 40 is located between the ballast frame 16 and the second counterweight element 24 in the scaffolded state.

Coupling of the ballast cylinders 18 to the connection elements 30 is effected in particular by rotation of the upper carriage 14 about its axis of rotation 13. For this reason, the recesses 41 of the carrier plate 40, through which the connection elements 30 project, are correspondingly widened, at least in the region of the coupling portions 36, so that the ballast cylinders 18 can be inserted downwardly into the recesses 41 next to the connection elements 30 until the coupling pieces are at the level of the receptacles 37 of the coupling portions 36. Coupling can then be established by rotating the upper carriage 14. To ensure that the coupling pieces of the ballast cylinders 18 are not moved through the receptacles 37 but reach their correct locking position, the recesses 41 are preferably configured in such a way that their lateral walls form corresponding mechanical stops for the coupling pieces of the ballast cylinders 18. In this way, overriding of the ballast cylinders 18 is simply and effectively prevented.

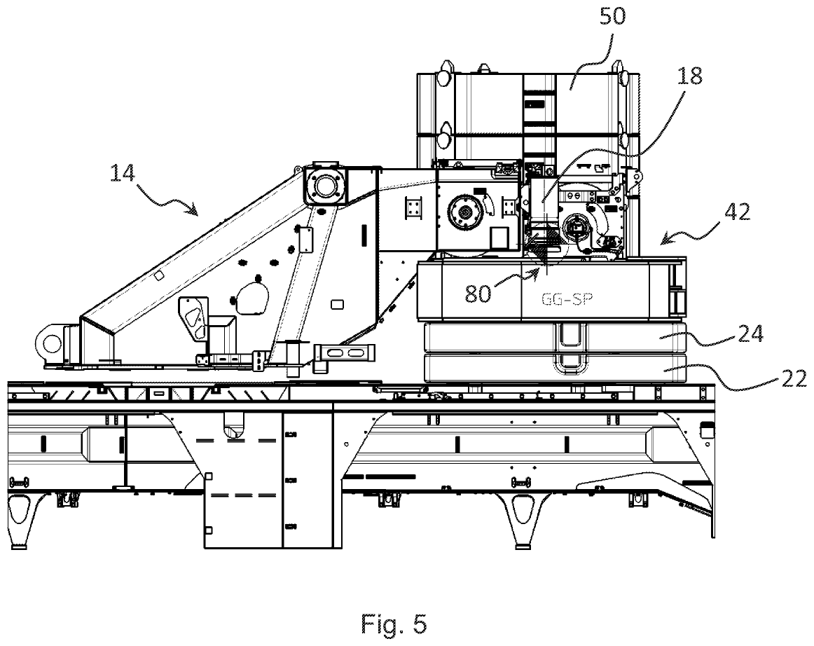

FIGS. 4-9 show the counterweight device 20 in various positions of the pivot beams 42, respectively in a plan view (FIGS. 4, 6, 8) and in a side view (FIGS. 5, 7, 9).

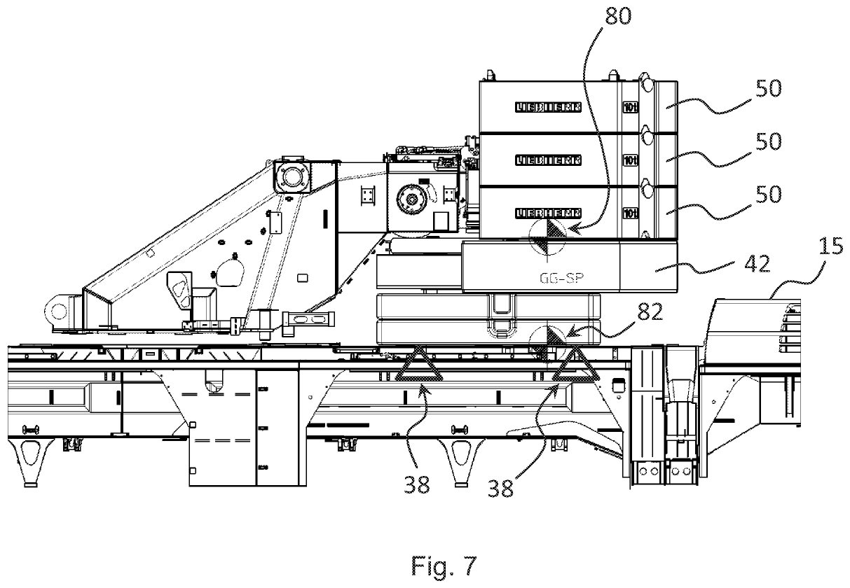

In FIGS. 4-5, the counterweight device 20 is still parked on the support area of the undercarriage 12, i.e. not yet mounted on the upper carriage 14, and the pivot beams 42 are in the first position. The hydraulic cylinders 44 are fully retracted and the pivot beams 42 rest against the carrier plate 40. In FIG. 5, the front counterweight stack 50, as viewed from the front, is hidden to reveal the ballast device, which is located between the two counterweight stacks 50. The overall center of gravity 80 of the counterweight device 20 is located in the area of action of the ballast cylinders 18, i.e., in plan view within the area spanned by the support surfaces 38 of the counterweight base plate 22 (cf. FIG. 5 and also FIG. 7, in which the support surfaces 38 are drawn as triangles for illustration purposes). As a result, the counterweight device 20 in this configuration stands stably on the support area of the undercarriage 12 without tilting and can be ballasted safely.

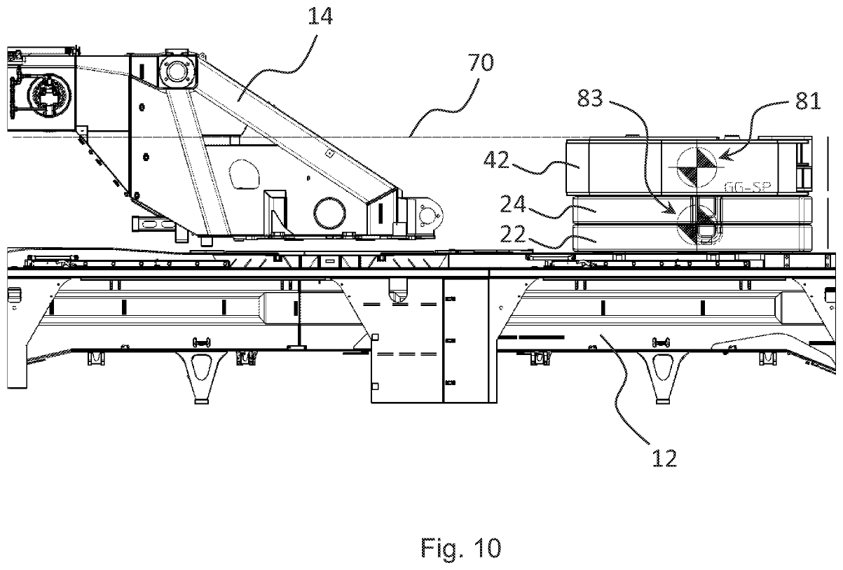

In FIG. 5, it can be seen that the unit consisting of counterweight base plate 22, second counterweight element 24 and carrier plate 40 is configured in such a way that their overall height is less than the distance between the support area of the undercarriage 12 and the lower edge of the ballast frame 16, i.e. the upper edge of the carrier plate 40 lies below the lower edge of the ballast frame 16. Thus, the latter can be moved over the carrier plate 40 without causing a collision. This is clearly demonstrated in FIG. 10, where the drawn line 70 indicates the height of the lowest edge of the ballast device or of the upper carriage 14 in the area of the ballast device. This line 70 is above the carrier plate 40, so the upper carriage 14 is free to pivot over the carrier plate 40. When the counterweight device 20 is equipped, the ballast radius is minimized in the first position, so that the upper carriage 14 requires less space when turning. At the same time, however, the counterweight moment is also reduced to the smallest possible amount.

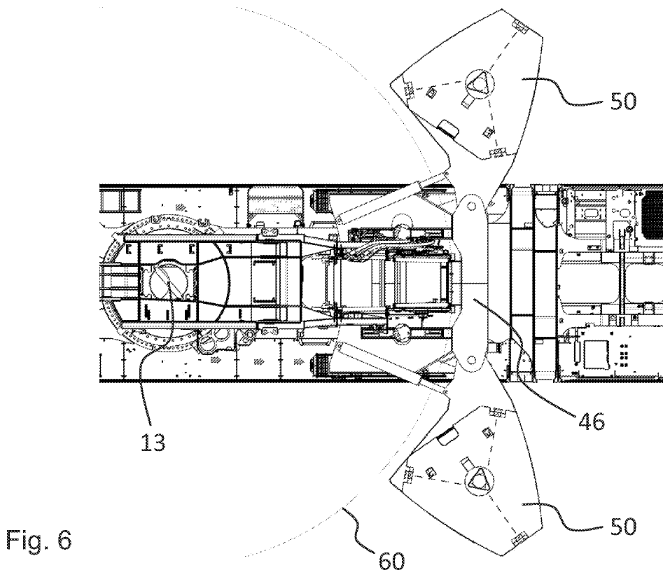

FIGS. 6-7 show the counterweight device 20 still parked on the support area of the undercarriage 12. However, the pivot beams 42 together with the counterweight stacks 50 have been pivoted out via the pivot drives 44 to a second position in which the ballast frame 16 just no longer collides with the first counterweight elements 50 when the upper carriage 14 is rotated relative to the counterweight device 20, which has not yet been mounted. This is indicated in FIG. 6 by the drawn circular path 60, which represents the path of the rearmost edge of the ballast frame 16 when the upper carriage 14 is rotated. In particular, the second position is the position of the pivot beams 42 in which the first counterweight elements 50 are just outside the circular path 60. In the second position, the pivot members 42 may be pivoted through an angle of 40° to 50° relative to the first position, for example 46°.

Due to the height of the unit consisting of counterweight base plate 22, second counterweight element 24 and carrier plate 40, the upper carriage 14 can be moved freely over the carrier plate 40 and the pivot beams 42 during setup if there are no first counterweight elements 50 on the pivot beams 42. However, if it is to be possible to support the first counterweight elements 50 on the pivot beams 42 in self-assembly of the mobile crane 10, the upper carriage 14 must be able to rotate freely even if first counterweight elements 50 are already stacked. For this purpose, a temporary hydraulic connection can be established with the pivot drives 44 and the pivot beams 42 can be moved to the second position. In this position, the upper carriage 14 can rotate freely and stack the first counterweight elements 50 on the pivot beams 42 of the counterweight device 20 still parked on the undercarriage 12.

As can be seen in FIG. 7, the overall center of gravity 80 of the counterweight device 20 in the second position is still located (in plan view) within the outer contour of the counterweight base plate 22. The projection of the center of gravity 80 onto the support area of the undercarriage 12 is indicated by the triangle 82. Thus, even in this configuration, the counterweight device 20 is still stable on the support area of the undercarriage 12 without tipping.

It can also be seen in FIGS. 6 and 7 that the counterweight base plate 22, the second counterweight element 24, and the carrier plate 40 have some clearance from the engine housing 15. This additional space could be used to shorten the undercarriage 12, which would increase the maneuverability of the undercarriage 12.

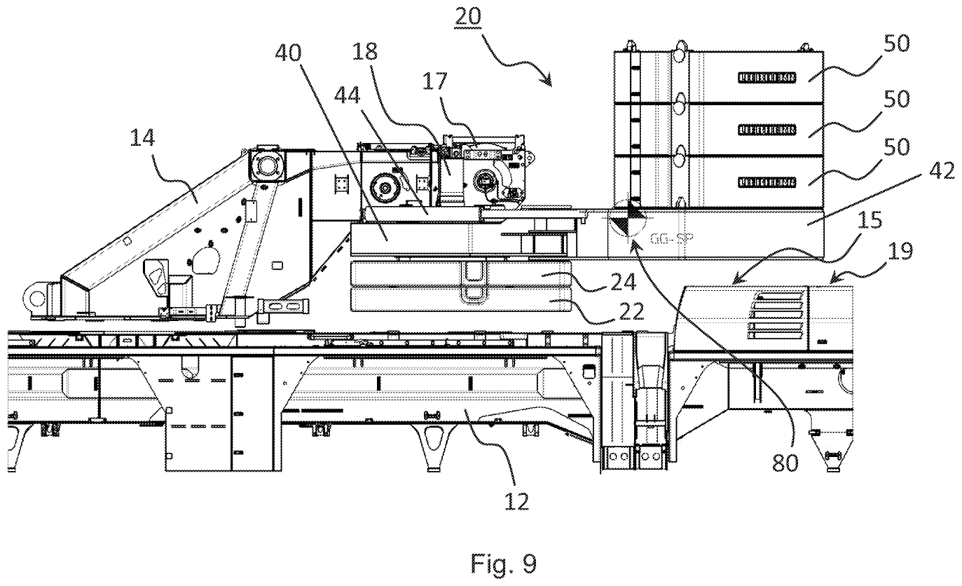

Finally, FIGS. 8-9 show the counterweight device 20 in a state mounted on the upper carriage 14. Here, the pivot beams 42 are pivoted out to a third position in which the hydraulic cylinders 44 are maximally extended and the pivot beams 42 are maximally pivoted out. In this configuration, the ballast radius is maximized, as is the counterweight moment generated by the counterweight device 20. In particular, in the third position, the pivot beams 42 are pivoted 120-150°, preferably 130-140°, relative to the first position. For example, the maximum pivot angle of each of the pivot beams 42 in the third position may be approximately 135°.

FIG. 9 shows a raised interference region of the undercarriage 12 relative to the storage region, adjacent to the storage region, which in this embodiment is a housing for an engine 15 and an exhaust aftertreatment device 19. This structure limits a widening of the counterweight base plate 22 and second counterweight element 24 to increase the counterweight moment. Due to the arrangement of the counterweight base plate 22, second counterweight element 24 and carrier plate 40 according to the disclosure, the pivot beams 42 are located above the upper edge of the housing of the engine 15 and exhaust gas aftertreatment device 19 when the counterweight device 20 is in the rigged state. The height of the pivot beams 42 thus allows the upper carriage 14 to rotate freely. This height is achieved by the counterweight base plate 22 and the second counterweight element 24.

In FIG. 8, it can be seen that the bolting between the connection elements 30 and the carrier plate 40 via the connecting means 32 performs an essential function. In the third position, the overall center of gravity 80 of the counterweight device 20 lies far outside the support surface, i.e., the outer contour of the counterweight base plate 22 or the support surfaces 38. If the carrier plate 40 merely rested on the support surfaces, it would tilt backward. Thus, a different force transmission is necessary to absorb the moment generated by the first counterweight elements 50. This is done by the fixed bolting 32.

Optionally, the connection elements 30 can have additional centering means in the area of the fastening means 34, via which the counterweight device 20 is automatically brought into the desired mounting position or pre-centered when the ballast cylinders 18 are retracted. The centering means can be configured, for example, as projections or mandrels projecting upwards in the longitudinal direction of the connection element 30 and tapering, and can interact with corresponding counter-centering means on the ballast frame 16, thereby ensuring automatic alignment of the counterweight device 20 when it is lifted on the ballast frame 16 by means of their beveled or conical contours.

It may be necessary to pivot the pivot beams 42 back to the first position to raise the counterweight device 20, so that the center of gravity of the counterweight device 20 is supported in a manner that allows the ballast cylinders 18 to safely support the counterweight.

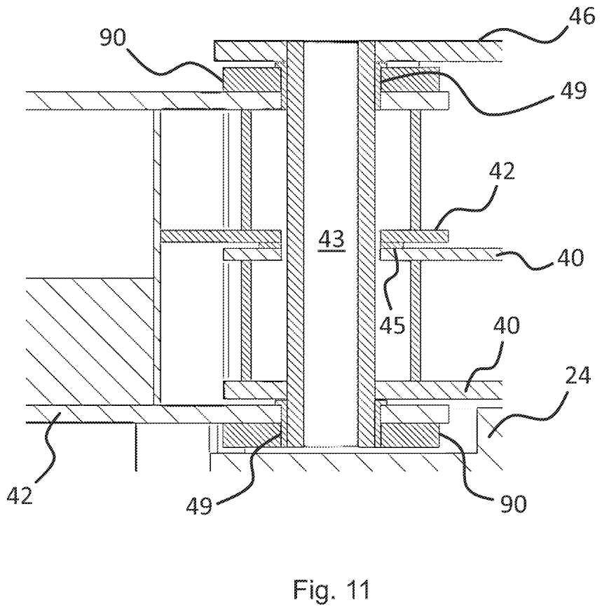

FIG. 11 shows a sectional view of an embodiment of the pivot connection or pivot joint between the carrier plate 40 and one of the pivot members 42, the section being along the longitudinal axis of the vertical axis 43. It can be seen that the joint or shaft forming the vertical axis 43 passes through the pivot member 42, the carrier plate 40 and the connection portion 46 (upper termination). A portion of the second counterweight element 24 can still be seen below.

As shown in FIG. 11, the pivot joint may comprise two radial bearings 49, which may be arranged at the bearing points of the shaft 43 at the top and bottom of the pivot beam 42. Alternatively or additionally, a thrust bearing 45 can be arranged between two bearing sections of the pivot beam 42 and the carrier plate 40, which can preferably be arranged at the middle height of the shaft 43. This bearing arrangement allows radial and axial forces to be optimally absorbed and transmitted. The radial and/or axial bearings can be plain bearings, although rolling bearings are also conceivable in principle.

In addition, doublings 90 can be arranged at the end regions of the shaft 43, in particular between the pivot beam 42 and the connection portion 46 and/or between the pivot beam 42 and the second counterweight element 24. These can increase the contact surfaces of the radial plain bearings 49.

In the following, an exemplary embodiment for a method according to the disclosure for setting up or mounting the counterweight device 20 according to the disclosure on the upper carriage 14 of the mobile crane 10 is given.

The ballast base plate 22 with the connection elements 30 is placed on the support area of the undercarriage 12 in self-assembly (i.e. with the boom of the mobile crane 10).

The second counterweight element 24 is placed on the counterweight base plate 22 (alternatively, the carrier plate 40 may be disposed directly above the counterweight base plate 22 or multiple second counterweight elements 24 may be provided).

If the pivot beams 42 were removed from the carrier plate 40 for transport, they are now remounted on the carrier plate 40.

The carrier plate 40 is placed above the second counterweight element 24 on the support surfaces 31 of the connection elements 30, with the pivot beams in particular in the first position. In the first position, the center of gravity 81 of the carrier plate 40 and the pivot beams 42 (cf. FIG. 10—not to be confused with the overall center of gravity 80 of the counterweight device 20 when the carrier plate 40 is bolted to the connection elements 30) lies within a surface spanned by the support surfaces 31. Thus, the carrier plate 40 rests securely and stably on the support surfaces 31 without tilting. The upper carriage 14 can pivot freely over the carrier plate 40 (cf. FIG. 10, horizontal line 70).

The bolting 32 between the connection elements 30 and the carrier plate 40 is established. From this moment on, the sole center of gravity 81 is no longer decisive, but the center of gravity 80 of the entire counterweight device 20 (cf. FIG. 5). The projected position of the center of gravity 80 is within the area spanned by support points of the counterweight base plate 22 on the undercarriage 12 or within the outer contour of the counterweight base plate 22.

Optional: if first counterweight elements 50 are required on the pivot beams 42, the pivot beams 42 must be pivoted into the second position (ballasting position) (cf. FIG. 6, circular path 60). For this purpose, it is necessary to establish a hydraulic and, if necessary, electrical connection between the upper carriage 14 and the pivot drives 44. The first counterweight elements 50 cannot be pivoted over by the upper carriage 14. If the first counterweight elements 50 are not stacked, this step is not necessary. The upper carriage 14 is now freely rotatable in the second position of the pivot beams 42 (for this purpose, the supply must be released from the upper carriage 14 again beforehand) and the first counterweight elements 50 are stacked on the pivot beams 42 in self-assembly. After this, the overall center of gravity 80 is still within the outer contour of the counterweight base plate 22. If ballasting is to take place, the ballast frame 16 must be located between the counterweight towers 50. The hydraulic and, if necessary, electrical connection is then made to the upper carriage 14, for example when the bolt connection between the counterweight device 20 and the upper carriage 14 or ballast frame 16 has been made.

Alternatively, for counterweight stacking, the supply could also have been established with the undercarriage 12. Fewer coupling operations are necessary here, see for example DE 10 2016 005 505 A1.

The pivot beams 42 are preferably pivoted back in until the center of gravity 80 of the entire counterweight device 20 to be lifted is suitably positioned relative to the ballast cylinders 18 (this need not necessarily correspond to the first position, but may be an intermediate position between the first and second positions), so that the counterweight device can be lifted safely from them and no excessive moments act on the ballast cylinders 18.

The upper carriage 14 is rotated about the vertical axis of rotation 13 to bring the counterweight device 20 into a lifting position in which the coupling pieces of the ballast cylinders 18 can be inserted into the recesses 41 adjacent to the coupling portions 36 of the connection elements 30.

By rotating the upper carriage 14 relative to the counterweight device 20, the coupling pieces of the ballast cylinders 18 move along circular paths into the receptacles 37 of the connection elements 30. If necessary, locking can take place.

Now the entire counterweight device 20 is lifted via the ballast cylinders 18 until the counterweight device 20 reaches its mounting position on the upper carriage 14 or ballast frame 16. Here, a pre-centering can optionally take place via centering means of the connection elements 30.

Finally, the bolt connections are made between the fastening means 34 of the connection elements 30 and corresponding fastening means on the ballast frame 16 (and, if applicable, on an area of the upper carriage steel frame adjacent to the ballast frame 16). The counterweight device 20 is now securely attached to the upper carriage 14 and the mobile crane is ready for operation.

In one embodiment, the carrier plate 40 and the pivot beams 42 may have a concrete filling. If the masses are chosen low enough, the unit consisting of counterweight base plate 22, second counterweight element 24, carrier plate 40 and the two pivot beams 42 can be moved as a common transport unit, eliminating the need for time-consuming assembly and disassembly. The lower mass can be compensated for by a higher ballast radius in crane operation.

One possible embodiment may include the following masses of the various elements: Counterweight base plate: 12 t, second counterweight element: 11 t, carrier plate: 4 t, each of the pivot beams: 4 t. Of course, these are only example values, which may differ depending on the design and application. For example, the carrier plate 40 could have a mass of 4 t, 8 t, or 10 t, or any other mass. Each of the pivot beams 42 could have a mass of 4 t, 8 t, 10 t, or any other mass. Also, the masses of the counterweight base plate 22 and the second counterweight element 24 may be any different from the specified values. The first counterweight elements may have masses of 10 t each, but may also have lesser or greater masses.

The ballast frame 16 may comprise two bending supports, which comprise the connecting means for fastening the counterweight device 20 via the connection elements 30. The connecting means of the ballast frame 16 are realized in particular as bolt receptacles or bolt eyes, with which the bolt receptacles 35 of the connection elements 30 can be brought into overlap, so that bolting can take place. These bolt receptacles can be located inside the bending supports and/or be implemented as separate sheet metal inserts to prevent them from being torn out of the upper carriage 14 or the ballast frame 16. The flexure beams may include additional stiffening elements or ribs to increase stability.

FIGS. 1-11 are drawn to scale, although other relative dimensions may be used, if desired.

### LIST OF REFERENCE CHARACTERS

1 mobile crane (state of the art)
2 counterweight base plate (state of the art)
3 counterweight plates (state of the art)
4 connecting means (state of the art)
5 counterweight (state of the art)
10 mobile crane
12 undercarriage
13 axis of rotation
14 upper carriage
15 engine housing
16 ballast frame
17 winch
18 ballast cylinder
19 exhaust gas aftertreatment device
20 counterweight device
22 counterweight base plate
24 second counterweight element
30 connection element
31 support surface
32 connecting means (bolt receptacle)
34 fastening means
35 bolt receptacle
36 coupling portion
37 receptacle
38 support surfaces
40 carrier plate
41 recess
42 pivot beam
43 vertical axis
44 pivot drive
45 axial bearing
46 connection portion
47 counter support surface
48 recess for mounting device
49 radial bearing
50 first counterweight element
52 recess for mounting device
60 circular path
70 lower edge of ballast device
80 center of gravity counterweight device (carrier plate 40 bolted)
81 center of gravity (essentially carrier plate 40 with pivot beams 42)
82 projected center of gravity
83 center of gravity (essentially of counterweight base plate 22, second counterweight element 24 and connection elements 30).
90 Doublings

1. Mobile crane comprising a mobile undercarriage, an upper carriage rotatably mounted on the undercarriage, and a counterweight device that can be coupled to the upper carriage, which comprises a counterweight base plate and at least one connecting member extending substantially perpendicular to the counterweight base plate and connected thereto for lifting the counterweight device and coupling the counterweight device to the upper carriage,
wherein
the counterweight device comprises a carrier plate which can be connected above the counterweight base plate to the at least one connection element, wherein at least one pivot beam is mounted on the carrier plate such that it can pivot about a vertical axis, on which pivot beam at least one first counterweight element can be stacked.

2. Mobile crane according to claim 1, wherein the at least one connection element is firmly connected to the counterweight base plate or is received in a recess of the counterweight base plate.

3. Mobile crane according to claim 1, wherein a ballast device is provided on the upper carriage, which ballast device is arranged to lift the counterweight device from a support area of the undercarriage and to place it thereon, wherein the at least one connection element comprises, at an end opposite the counterweight base plate, a coupling portion via which a coupling with the ballast device can be established, wherein the ballast device comprises a ballast frame that can be connected to the upper carriage via fastening means.

4. Mobile crane according to claim 3, wherein the ballast device comprises at least one hydraulic ballast cylinder which is releasably engageable with the coupling portion of the at least one connection element, wherein the coupling portion comprises a receptacle into which a coupling piece of the ballast cylinder is retractable by rotation of the upper carriage about its axis of rotation.

5. Mobile crane according to claim 1, further comprising at least one second counterweight element stackable on the counterweight base plate and having at least one recess through which the at least one connection element protrudes in the put-down state, wherein the second counterweight element is arranged between the counterweight base plate and the carrier plate in the ballasted state.

6. Mobile crane according to claim 1, wherein the counterweight device comprises at least two connection elements spaced apart from one another and arranged at the same distance from the center of gravity of the counterweight base plate and/or at least two pivot beams mounted on the carrier plate so as to be pivotable about a vertical axis in each case.

7. Mobile crane according to claim 4, wherein the at least one connection element comprises one or more of the following:
a support area via which the counterweight base plate rests on the connection element and introduces its weight force at least in the absence of an inclined position of the mobile crane,
a centering means by means of which the counterweight device can be automatically positioned in a mounting position during lifting on the upper carriage,
a fastening means via which the counterweight device can be releasably connected to the upper carriage in a mounting position, wherein the fastening means comprises a bolt receptacle for producing a bolt connection to the upper carriage.

8. Mobile crane according to claim 1, wherein the at least one pivot beam can be pivoted continuously relative to the carrier plate via a pivot drive wherein the pivot angle of the pivot beam can be detected via at least one sensor.

9. Mobile crane according to claim 7, wherein the at least one connection element comprises a support surface on which the carrier plate can be placed in such a way that the weight force of the put-down carrier plate is introduced only into the at least one connection element and not into the counterweight base plate or a second counterweight element placed thereon.

10. Mobile crane according to claim 3, wherein the carrier plate comprises at least one recess through which the at least one connection element projects in the connected state, wherein the end of the connection element projecting through the carrier plate comprises a fastening means via which the counterweight device can be detachably connected to the upper carriage, wherein the recess is formed such that a coupling piece of a ballast cylinder of the upper carriage can be positioned next to a coupling portion of the connection element within the recess and can be retracted into a receptacle of the coupling portion by rotation of the upper carriage about its vertical axis of rotation.

11. Mobile crane according to claim 9, wherein the carrier plate and the at least one connection element each comprise connecting means for establishing a detachable connection, including a bolt connection, with one another.

12. Mobile crane according to claim 1, wherein the at least one first counterweight element is movable by pivoting the pivot beam from a first position abutting the carrier plate to a second position in which the upper carriage is rotatable relative to the counterweight device without colliding therewith when the connection to the counterweight device is released, wherein the at least one first counterweight element has a substantially triangular basic shape.

13. Counterweight device for a mobile crane according to claim 1, further comprising at least one first counterweight element stackable on the pivot beam and/or at least one second counterweight element stackable on the counterweight base plate.

14. Method for mounting the counterweight device on the upper carriage of a mobile crane according to claim 11, comprising the following steps:
placing the counterweight base plate on a support area of the undercarriage, including by means of a boom attached to the upper carriage of the mobile crane,
connecting the carrier plate to the at least one connection element,
lifting the counterweight device via the at least one connection element,
producing a connection between the at least one connection element, including a fastening means of the connection element projecting through the carrier plate, and the upper carriage, including a ballast device of the upper carriage.

15. Method according to claim 14, wherein a step of connecting the carrier plate to the at least one connection element comprises the following steps:
bringing the carrier plate to the at least one connection element, including by means of the boom of the mobile crane,
inserting the at least one connection element into the corresponding recess of the carrier plate,
placing the carrier plate on the support surface of the at least one connection element so that the carrier plate rests completely thereon,
connecting the carrier plate to the at least one connection element via the connecting means.
